(19) United States
(12) Patent Application Publication
(10) Pub. No.: US 2025/0217736 A1
(43) Pub. Date: Jul. 3, 2025

(54) INTEGRATED PROJECT MANAGEMENT AND RESOURCE ALLOCATION SYSTEM

(71) Applicant: Project Data, LLC dba InScope, Chesterfield, MO (US)

(72) Inventors: Kevin Neal Corwin, O'Fallon, MO (US); Mark E. Meyer, Ballwin, MO (US)

(73) Assignee: Project Data, LLC dba InScope, Chesterfield, MO (US)

(21) Appl. No.: 18/950,264

(22) Filed: Nov. 18, 2024

Related U.S. Application Data
(60) Provisional application No. 63/616,076, filed on Dec. 29, 2023.

(51) Int. Cl. G06Q 10/0631

(52) U.S. Cl. CPC G06Q 10/06314

(57) ABSTRACT

The work breakdown structure (WBS) table in a computerized project management system is modified to include individual columns for each of the resources that is used on a project to produce a scope-resource matrix within the WBS table. The matrix is created when users add each resource directly to a project's WBS table. The users assign the resources to individual tasks and subtasks in the project by adding the allocation level directly the matrix at the intersection of the resource and each task to which the resource is assigned. Also, the computerized project management system automatically reformats selected task rows in the WBS table from their original data field format to a composite operator-data field format when a user adds subtasks to the selected task row. The computerized project management system also allows users to group columns in the WBS table, and the grouped columns can be shown or hidden.

### TECHNICAL FIELD

The subject matter relates to project management systems, and more particularly to project management systems in which resources are allocated to various tasks in the scope of work.

### BACKGROUND

Software tools have been developed to assist with managing the tasks within a scope of work for a project along with the resources that it will take to perform the work and the schedule of time for performing the various tasks. Many of these project management software tools include the ability to graphically display the tasks in timelines according to the schedule set for the various tasks in one or more projects, such as shown and generally described in U.S. Pat. No. 8,706,535 which is incorporated by reference herein, and this is commonly referred to as a Gantt chart. At the core of each one of these project management software tools is a database which correlates the tasks in the scope of work with their respective dates in the schedule of time and the corresponding resources for performing the tasks within the respective time periods. Accordingly, the database has scope fields, resource fields, and schedule fields which are correlated to each other (i.e., task to resource, task to schedule, and resource to schedule).

One of the primary objectives of successful project management software tools is to help the users more efficiently define the tasks to be performed for a scope of work and to assign the resources that are going to perform the work for the particular tasks and schedule the time that will be needed for the resources on the various tasks. Advanced project management software tools may also evaluate the data entered by the user to identify possible overallocation of resources, underutilization of resources, unassigned and unallocated tasks, and the finances (costs, budgets, etc.) resulting from resources. Accordingly, the software tools help users enter the respective scope data, resource data, and schedule data within the fields which associate scope management, resource management, schedule management, and cost management as the basic tenants of their projects. Facilitating the allocation of the amounts and/or costs of resources (personnel, equipment, vendors, etc.) to be budgeted and consumed in the performance of scopes of work on projects is a function of virtually every project management software tool.

One of the ways that nearly all project management software tools help users efficiently enter and display the data is with a work breakdown structure (WBS) in which a project's scope of work is broken it down into its various components, usually in a hierarchical format, such as phases, stages, and tasks which are generally referred to herein as tasks and subtasks. Through the software tool's user interfaces, the user can set the periods of time for each one of the tasks and subtasks in the schedule for the work and can also define the resources that will be used to perform the tasks and subtasks, assign the defined resources to the various tasks and subtasks, and allocate amounts and/or costs to be budgeted and consumed by the resource as the work is performed.

Typically, the project management software tools display the WBS in a columnar arrangement on the screen to provide the user with a visual representation of the scope. The project management software tools allow users to add tasks and subtasks as the scope elements in the scope of work and to modify these tasks and subtasks. In most project management software tools, each one of the tasks and subtasks and their respective descriptions and other scope details are displayed on their own individual rows in one or more WBS columns. The schedule for these tasks and subtasks is provided in the same columnar format with the WBS scope columns which allows the user to enter a start date and an end date in the row of each corresponding one of the tasks and subtasks. In this same WBS workspace view with scope columns and schedule columns, the project management software tools can also graphically display the Gantt chart, i.e., timeline for the various tasks. In setting the periods of time for the tasks and subtasks, a specific start date and end date may be entered for some while other tasks and subtasks may have a start date that is based on the end date of another task or subtask which can create interdependencies between tasks that can also be shown on the graphical display.

When it comes to the interfaces for the display and entry of resources associated with the tasks and subtasks, currently known project management software tools typically require the user to enter the resources on a display screen that is either entirely separate from the WBS workspace view or requires multiple popup windows over the WBS workspace view. For example, in the project management software system disclosed in U.S. Pat. No. 9,270,737, which is incorporated by reference herein, when the user selects a user input mechanism that is displayed on the WBS workspace view, a separate resource display section is opened as a popup window over the WBS workspace view for each task to allow the user to enter the resource allocation data. In yet other project management software systems, such as disclosed in U.S. Pat. No. 11,263,565 which is incorporated by reference herein, a single column on the WBS workspace view can be used to display the resources that are assigned to the respective tasks, but the user is still presented with separate popup windows to assign the resources to each one of the corresponding tasks. In none of the known project management software tools' user interfaces can a user simultaneously display all of the defined resources on the WBS workspace view and enter data to both assign and allocate the defined resources to the tasks and subtasks on the same WBS workspace view that is used for displaying the WBS data columns and the schedule data columns.

The screen displays that traditional project management software tools provide to users to help them define resources and assign and allocate the defined resources to the tasks and subtasks are cumbersome, counterintuitive, time consuming, and inefficient when multiple resources must be associated to multiple scope elements, i.e., tasks and subtasks, at multiple levels of allocation. The traditional tools' interfaces require isolated, individual user actions which require users to navigate to different workspaces within the interface. An example of a prior art popup window interface is shown in FIG. 1A with annotations referring to the operations that must be performed to assign a resource to a task and to enter an allocation for the assigned resource for the particular task: a scope element is first selected in the WBS workspace view; a popup window or secondary workspace view then opens for the selected scope element, and a resource to be assigned to the scope element must be selected; the allocation of amount or cost for the assigned resource is then entered for the particular scope element; with the popup window still open for the scope element, the assigning process and the allocating process are repeated for each one of the resources used to perform the scope element; the user must then close the popup window and navigate to another scope element in the original WBS workspace view so the user can repeat the processes for selecting the next scope element for another popup window associated with this particular scope element and then repeatedly performs the assigning process and the allocating process for each one of the resources used to perform this scope element.

Similar to the single column listing of resources referred to above with reference to the '565 Patent, the prior art WBS workspace views shown in FIGS. 1B and 1C show a single column listing of resources corresponding to the rows of tasks. These prior art WBS workspaces list multiple resources within each row of the single resource column, and the WBS workspace in FIG. 1B also includes a single column with rows of allocation percentages. While this single column view of the resources on the WBS workspace is helpful because it could help the user readily identify tasks that do not have any resources assigned to them, i.e., unassigned tasks, it fails to provide sufficient granularity in the data for the user to allocate different levels of effort, such as with different allocation percentages, for the different resources that are working on the same task. Instead, the WBS workspace view in this prior art reference only allows a single allocation percentage to every one of the resources assigned to each particular task. The default for this prior art system is to apply the allocation percentage to any resource assigned to the corresponding tasks, even for a row of tasks with multiple resources that may require an allocation of different levels of effort. In order to vary the allocation for the various resources assigned to a task, the user would have to open the separate resource management workspace for each task and enter the allocation data. Additionally, in order to assign a resource to any particular task in this prior art WBS workspace view, the user has to open a menu window that lists the resources, and then select each resource to be assigned to the task. Similar to the example discussed above with reference to FIG. 1A, the user would have to repeat the assigning process for the resources to be assigned to each one of the tasks.

As evident from the examples provided in FIGS. 1A and 1B, the traditional WBS workspace views that facilitate the process of allocating resources to tasks in a scope of work are cumbersome, counterintuitive, time consuming, and inefficient, especially when more than a few resources must be associated to many tasks at various levels of allocation. The traditional interfaces require isolated, individual user actions which require users to navigate to different screens or workspaces that the software tools display to the user. It has been recognized that the typical project management software tools have a problem with the visual separation between the tasks in the scope of work and the assignment and allocation of resources, and there has been a desire to resolve this problem. For example, U.S. Pat. No. 9,818,076 which is incorporated by reference herein, describes the visual separation problem, noting that Gantt charts which can be shown on the WBS workspace view typically fail to visually indicate any information about resources assigned to various tasks and do not provide a way for a user to reallocate resources among tasks.

According to the '076 Patent, known project management systems provide users with separate resource allocation charts that display an allocation of a resource over a time scale, but these resource allocation charts typically do not display task information evident from the Gantt chart, such as interdependencies between tasks. In evaluating known project management systems, the '076 Patent concludes that there is no easy way of allocating or de-allocating tasks with a resource using a resource allocation chart. The '076 Patent notes that a resource allocation chart typically does not allow managing of other attributes of a task, such as a start date-time, a finish date-time, an allocation, etc. The result is a user typically has to frequently switch between a Gantt chart and a resource allocation chart to effectively plan tasks and allocate resources. The '076 Patent proposes a visual resource allocation system to solve these problems in project management systems by extending the functionality of a Gantt chart to present a unified, single view of task duration and resource allocation. However, the particular solution proposed by the '076 Patent is the segmentation of task indicators according to the resources that are allocated to the task, and this solution would still require an iterative methodology similar to the processes repeated above for each one of the tasks shown in the Gantt chart. Additionally, due to the segmentation of task indicators, this solution is best suited to small projects with a relatively small number of resources because it would become more challenging to display all of the segmented resources as more resources are added, and it would be unwieldy for large projects.

The '076 Patent suggests that each task indicator segment can include resource information, including (1) a name of a resource, (2) a background fill color that represents a role of the resource, (3) a throughput of the resource, and (4) a percentage resource utilization of the resource for the corresponding task. An example of a task with two (2) tractors and two (2) farmers is provided. Since the task has four (4) resources, the '076 Patent would segment the task indicator into four (4) task indicator segments that represent the respective resources. The task indicator segments would be cut across a height dimension, and the two (2) task indicator segments representing the two tractors would have a particular fill color while the two (2) task indicator segments that represent the two farmers would have a different fill color. Further, each task indicator segment can include a name of a corresponding resource, a throughput of the resource, and a resource percentage utilization of the resource for the task. Although the '076 Patent's solution of task indicator segments may be workable for managing projects with a very limited number of resources, it will be apparent to persons of ordinary skill in the art that this solution is unworkable for most projects which may use dozens, scores, or even hundreds. Accordingly, there remains a need for an integrated approach in project management systems in which the resources that are used for the tasks in the WBS can be simultaneously displayed in the WBS columnar formatted screen with so the resource information can be viewed and entered together without having to open and work in a separate workspace such as the separate resource allocation workspace described above and in the '076 Patent or open and navigate to task-specific workspaces, such as the popup resource allocation workspace. The individual resource allocation could take place in each row set to be associated to an individual resource (though not taught or suggested by the '076 Patent, only a Gantt bar for each resource); even if this were to be the case, an individual resource selection per row would be needed to assign each respective task/subtask.

Some project management software tools include their own resource allocation workspaces, while other project management software tools exchange data with a separate resource management software tool. A provider of resource management software recommends that users perform resource allocation in a separate resource management software tool while the users perform the detailed task allocation in their respective project management software tools (www.float.com/resources/guide-to-resource-allocation/“Resource allocation should be done in your resource management software, while your detailed task allocation should be done in your project management tool.”). In some project management software systems, users enter the resource data into a workload screen which is entirely separate from the WBS workspace view. For example, in a resource management software tool, the resources are displayed on different rows in a single column, and the tasks and subtasks in which the resource is assigned are provided in rows beneath the resource, such as shown in FIG. 1D. The allocation of the resources according to the schedule can be shown with columns of dates and/or a graphical timeline for the various tasks and subtasks for the various resources. However, in addition to requiring the user to view the resource data in the separate workload view or other resource management interface which is a significant shortcoming, there are additional shortcomings because a single task must be assigned to a single resource one at a time and unassigned and unallocated scopes may be missed because they are not displayed in the workload view.

Project management software tools also help users facilitate the allocation of amounts or costs of resources (personnel, equipment, material, subcontractors and vendors, etc.), time durations, and other values to be budgeted and consumed in the performance of scope elements that are defined in the scope of work for the projects. Traditional project management software tools restrict the fields associated with scope elements to be a single format, such as a data field or an operator field. Examples of data fields include numerical values, such as hours of work or expenses or days of rental, and could also be dates or may even be text, symbols or other status indicators in some instances. Examples of operator fields are equations or any other formula that operates on one or more data fields. Accordingly, scope elements that are higher level tasks, i.e., parent tasks, and which have been broken down into subtasks, i.e., child tasks, typically are formatted as operator fields which summarize or aggregate the data fields in one or more lower level subtasks. The operator fields are limited to single formulas that produce calculated values based on the values in the data fields in the subtasks. Based on this binary approach to fields being either a data field or an operator field, there is no way for a parent task to include a value in addition to providing the operator for its subtasks. Some project management systems provide users with the option to add information into a popup window, but this is cumbersome and fails to provide the user with the same data functionality found in the original data field.

There are times when managers would like to keep a separate value associated with an original task even after it has been broken down into multiple child tasks. Since current project management software systems automatically change the fields in parent rows to be operator fields, managers would have to create a separate dummy row to hold the data fields that had been in the original row which requires multiple manual actions and is inefficient. Accordingly, it would be beneficial to automatically create parent rows which are a hybrid of data fields and operator fields so that the managers have the option on how to distribute the data in the child rows.

Examples of references in the same general field or in similar technical fields are described in the patents listed below and which are hereby incorporated by reference herein.

| U.S. Pat. No. | U.S. Pat. No. | U.S. Pat. No. | U.S. Pat. No. | U.S. Pat. No. | U.S. Pat. No. |
|---|---|---|---|---|---|
| 5,255,356 | 7,725,820 | 8,706,535 | 8,856,246 | 9,652,446 | 9,720,737 |
| U.S. Pat. No. | U.S. Pat. No. | U.S. Pat. No. | U.S. Pat. No. | U.S. Pat. No. | U.S. Pat. No. |
| 9,818,076 | 10,338,764 | 10,949,254 | 11,113,667 | 11,263,565 | 11,734,628 |
| U.S. Pat. No. | U.S. Pat. No. | | | | |
| 11,748,709 | 11,809,816 | | | | |

### SUMMARY

One aspect of the present disclosure is the expansion of the work breakdown structure table to include individual columns for each of the resources that is used on a project to produce an innovative scope-resource matrix within the work breakdown structure table. The matrix is created when users add each resource directly to the work breakdown structure table for a project. The users can then assign the resources to individual tasks and subtasks in the project by adding the allocation level directly the matrix in the work breakdown structure table at the intersection of the resource and each task to which the resource is assigned.

Another aspect of the present disclosure is the automatic reformatting of a selected task row in the work breakdown structure table when a user adds subtasks to the selected task row. In particular, when subtasks are added to the selected task row, the original data field format of the selected task row is changed to have an innovative format as a composite operator-data field.

Yet another aspect of the present disclosure is the unique grouping of columns in the work breakdown structure table.

Further areas of applicability of the present disclosure will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

Illustrative aspects of the present application are described in detail below with reference to the following drawing figures:

FIGS. 1A to 1H illustrate a project management system;

FIG. 2 illustrates a project management software tool configured as a software-as-a-service (SAAS) model in accordance with some aspects of the disclosure;

FIGS. 3A and 3B illustrate a work breakdown structure (WBS) table with the scope of work in a column along the left-hand side of the WBS table in accordance with some aspects of the disclosure;

FIG. 4A illustrates a flowchart of a process for resource allocation using the scope-resource matrix in accordance with some aspects of the disclosure;

FIG. 4B illustrates a flowchart associated with a conventional process for resource allocation;

FIG. 5 illustrates scope to resource associations and the scope to schedule associations on the same enhanced WBS table workspace in accordance with some aspects of the disclosure;

FIGS. 6A and 6B illustrate a Gantt chart display in accordance with some aspects of the disclosure;

FIGS. 7A to 7C illustrate convert the scope-resource matrix for the allocated tasks into a workload table in accordance with some aspects of the disclosure;

FIG. 8 illustrates one or more rate tables in which each one of the resources can be assigned to a category in accordance with some aspects of the disclosure;

FIGS. 9A and 9B illustrate a composite operator-data field of a WBS tool in accordance with some aspects of the disclosure;

FIG. 10 illustrates subtask instruction from the input interface for a selected task in the set of tasks of a WBS tool in accordance with some aspects of the disclosure;

FIG. 11A to 11G illustrate example images of a WBS tool in accordance with some aspects of the disclosure;

FIG. 12 illustrates display of configurable columns of a WBS tool in accordance with some aspects of the disclosure;

FIG. 13 illustrates sockets and groups of columns of a WBS tool in accordance with some aspects of the disclosure;

FIG. 14 illustrates details of a socket of a WBS tool in accordance with some aspects of the disclosure and

FIG. 15 illustrates repositionable sockets of a WBS tool in accordance with some aspects of the disclosure; and

FIG. 16 illustrates adding data and partially contract forecast sockets of a WBS tool in accordance with some aspects of the disclosure.

### DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

Specific details are provided in the description above to provide a thorough understanding of the embodiments and examples provided herein, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

For clarity of explanation, in some instances the present technology may be presented as including individual functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The present disclosure is directed to improvements in project management software tools and includes three (3) innovations which are summarized below and then described in detail as they have been incorporated into the InScope project management software tool. Each one of the innovations generally relates to improvements in the format of the work breakdown structure (WBS) table that is used as the primary interface for entering data for projects and displaying the data. Accordingly, the WBS table serves as an interactive display for the project management software tool. The enhancements to the WBS table according to the present disclosure can be incorporated individually or together to improve the WBS tables of other project management software tools

One of the most significant innovations to the computer implemented WBS table is the addition of individual columns for the resources that are used on a project which produces a scope-resource matrix within the WBS table. The matrix is created when users add each resource directly to a project's WBS table. The users assign the resources to individual scope elements, i.e., tasks and subtasks, in the project by adding the allocation level directly to the matrix in resource allocation fields that are at the intersection of the resource and each task to which the resource is assigned. Another innovation the computer implemented WBS table is the automatic reformatting of selected task rows from their original data field format to a composite operator-data field format when a user adds subtasks to the selected task row. Finally, the computer implemented WBS table is further enhanced with an innovative grouping of the columns which allows grouped columns to be shown or hidden.

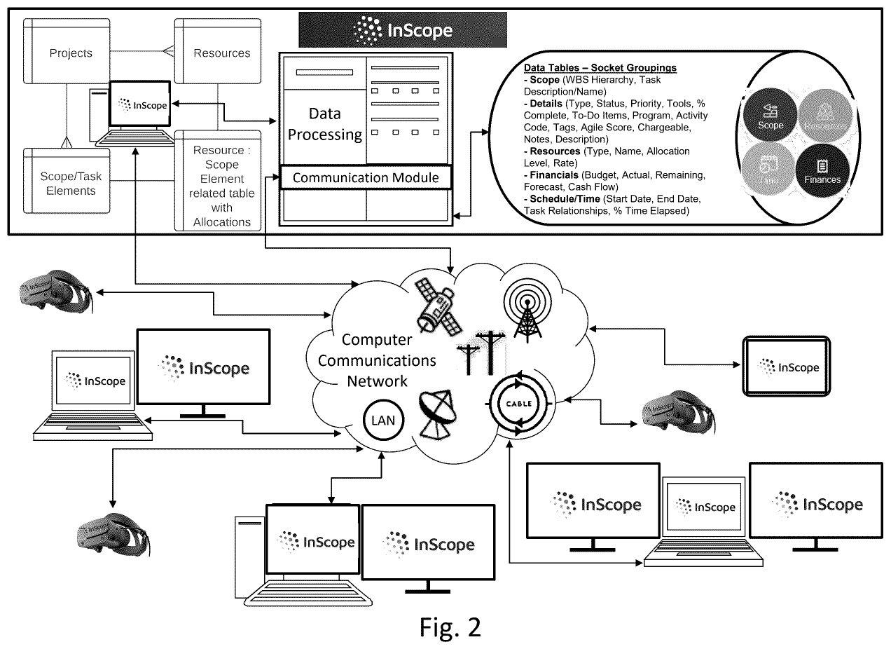

The project management software tool is preferably implemented in a software-as-a-service (SAAS) model as shown in the system diagram of FIG. 2. The project management software tool has three primary components which function together: a centralized server, a centralized database, and a distributed network of workflow computers that communicate with the centralized server and centralized database through a computer communications network. The centralized server has access to project information in the centralized database or in other data tables which could be distributed in the distributed network of workflow computers through the computer communications network. The workflow computers can be standard desktop computers or laptop computers, and could also be tablet computers or even smartphone devices, which use standard monitor screens, touchscreens, or may even use virtual reality (VR) and/or augmented reality (AR) headset monitors (or any other screen/monitor device which may be developed in the future). The workflow computers could also be tablet computers which have their own touchscreens. It will also be appreciated that the software tool could alternatively be implemented in local computer networks without departing from the innovative aspects of the present invention.

The basic data table structure for the project management software tool is similar to standard project management software to the extent that it establishes a fundamental relationship between project records of projects, particularly including tasks, schedules, and resources. However, as will be evident from the description of the disclosure below, the additional details included in the data tables allow for some of the enhanced functionality and innovations for viewing and interacting with the WBS table's workspace in the present invention. For example, the composite operator-data field format for tasks with subtasks, i.e., parent tasks with children tasks, that is used in the present disclosure requires the linkage of the operator with any data that is stored at the parent task level as well as the data that is stored in the subtasks, and there is no such linkage in the interfaces of presently known project management systems. Accordingly, this linkage must be built into the interface for the parent tasks so the computer processor can retrieve any data stored in the parent task's composite data-operator field and perform the operation on the parent task's data as well as the data in the subtask data fields. Additionally, although all of the data tables of most computer-implemented project management systems can store the allocation data necessary to build a scope-resource matrix in the WBS table, the ability to group the columns of data according to the present disclosure is preferably implemented with hierarchical levels of column groupings, and the interfaces and data table structure for known systems do not provide for any such groupings.

### Scope-Resource Matrix Innovation

Facilitating the allocation of the amounts or costs of resources (personnel, equipment, vendors, etc.) to be budgeted and consumed in the performance of scopes of work (sometimes called “tasks”) on projects is a function of virtually every project management software platform. It generally takes the form of breaking down a Scope of Work into component elements/tasks to be managed (a “work breakdown structure” or “WBS”); assigning the defined resources to various scope elements (or tasks and subtasks in a scope of work) and allocating amounts and/or costs to be budgeted and consumed by the resource as the work is performed.

The present disclosure enhances the traditional work breakdown structure (WBS) table to include a scope-resource matrix. The scope-resource matrix is produced in the WBS table by adding individual columns for each of the resources that is used on a project. The project management system allows users to add resources directly to the WBS table for a project which creates the scope-resource matrix in the WBS table. The users can then simultaneously assign and allocate the resources to individual scope elements in the project by adding the allocation level directly to the resource allocation fields in the WBS table's scope-resource matrix. The resource allocation fields are at the intersection of the resource and each task to which the resource is assigned. In the WBS table of the present invention, the scope-resource matrix has rows that correspond to each task in the scope of work and has columns that correspond to the resources available for the project. The level of effort, amounts and/or costs may be entered in the intersecting cells for the tasks and the allocated resources. As explained in detail below, the innovation of the scope-resource matrix provides a WBS interface that allows users to more efficiently enter data associated with the tasks and it also gives users better insight into the allocation of resources for a project and even over multiple projects that are being managed within the same project management software tool.

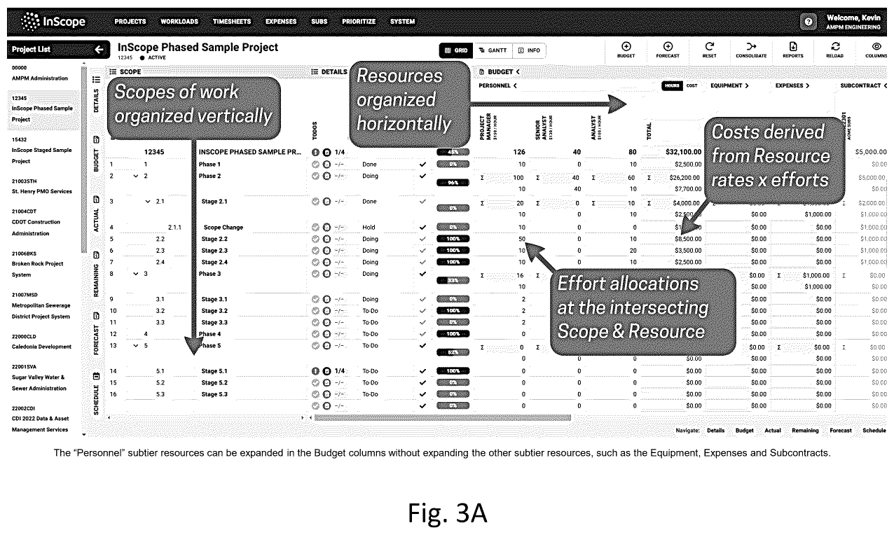

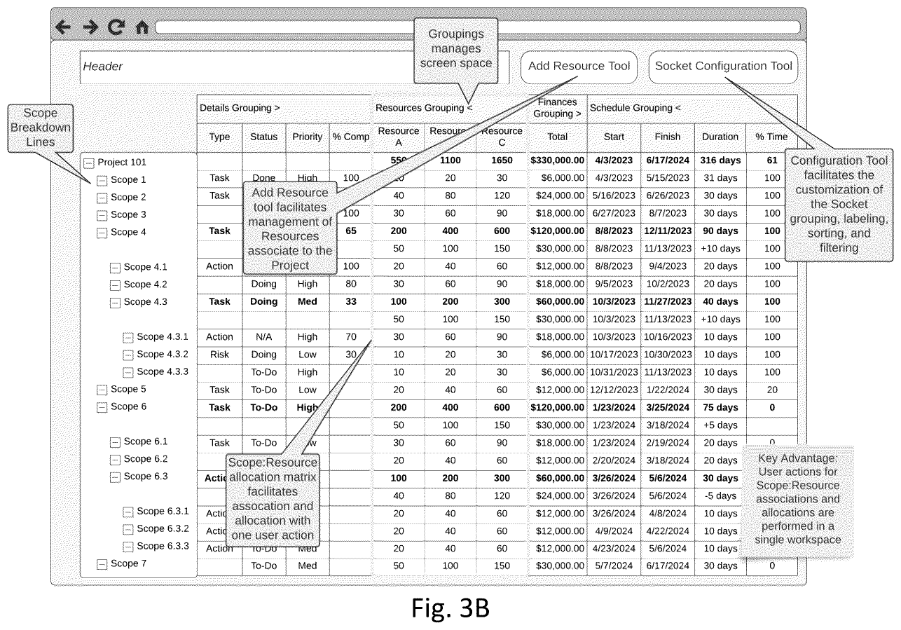

As with most computer-implemented project management systems, the present disclosure formats the WBS table with the scope of work in a column along the left-hand side of the WBS table, such as shown in FIGS. 3A and 3B, and the tasks and subtasks are arranged in rows extending down the scope of work column. Many project management systems allow users to manage multiple projects which share some or all of the resources that are available to the projects. Accordingly, each project is typically identified in a heading field positioned above the scope elements which are defined in various hierarchical levels depending on the user wants to divide out the scope of work for each one of the projects and the level of detail that is desired. Additionally, as with most computer-implemented project management systems, the WBS table includes schedule columns, such as columns with start date fields and end date fields that are arranged in rows corresponding to the rows for the respective tasks and subtasks. Accordingly, in the present invention, the data for the scope of work and schedule are organized and stacked vertically as in most other computer-implemented project management systems. The difference with present disclosure is that it also provides individual columns for each one of the resources that are being allocated to the various tasks and subtasks so the resource names are displayed in resource identifier fields arranged horizontally along the top edge of the WBS table, preferably at a fixed position at the top of the workspace screen that displays the WBS table so the resource names remain above the resource allocation data fields. The allocation values (expenses, level of effort, amount of material, number of pieces of rental equipment, etc.) for the various resources can be entered directly in the scope-resource matrix at the intersections of the task to be performed and each one of the resources that will be used in performing the task.

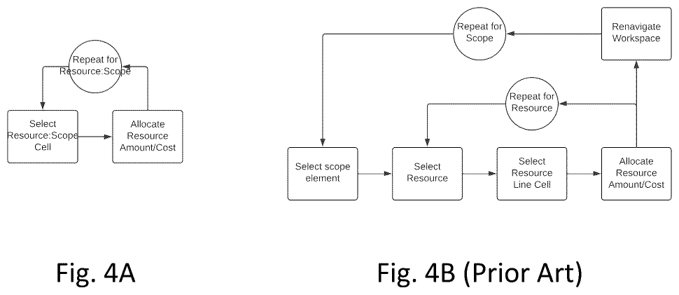

The scope-resource matrix is shown on the same WBS table as the schedule information so the scope to resource associations are being made on the same workspace as the scope to schedule associations. The most advantageous benefit of the scope-resource matrix is the efficiency with which the resources can be allocated as compared to the prior art methods. A flowchart of resource allocation using the scope-resource matrix is shown in FIG. 4A and is juxtaposed with a flowchart of resource allocation that uses the popup windows in a prior art system which is shown in FIG. 4B. The scope-resource matrix within the WBS table allows a user to allocate a resource in three (3) steps without having to navigate away from the WBS table. In comparison, the prior art system requires the user to perform additional steps, including steps that require the user to navigate away from the WBS table to the popup screen which is a different workspace from the WBS table and then navigate back to the WBS table, and these navigation steps result in significant delays in the allocation of the resources. The allocation steps of the present disclosure are listed below.
1. Select a cell in the scope-resource matrix on the WBS table. The selection defines the target resource column cell for a target scope element, i.e. a task or subtask.
2. Enter the amount into the selected cell. This entry allocates the amount (cost, level of effort, etc.) for the given resource on the given scope element.
3. Repeat the action for the next target scope element and target resource, never leaving the WBS table.

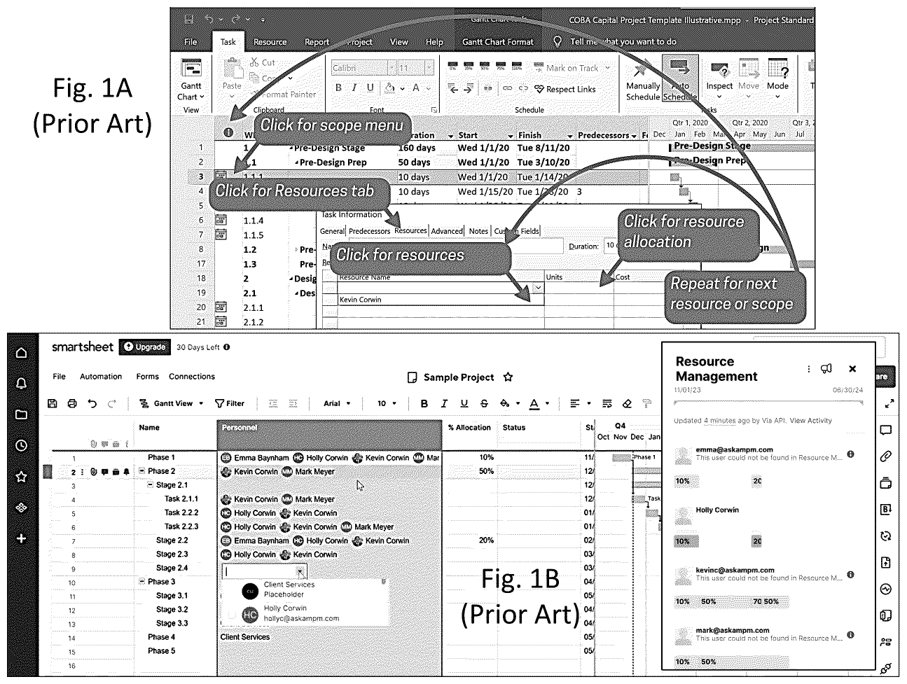

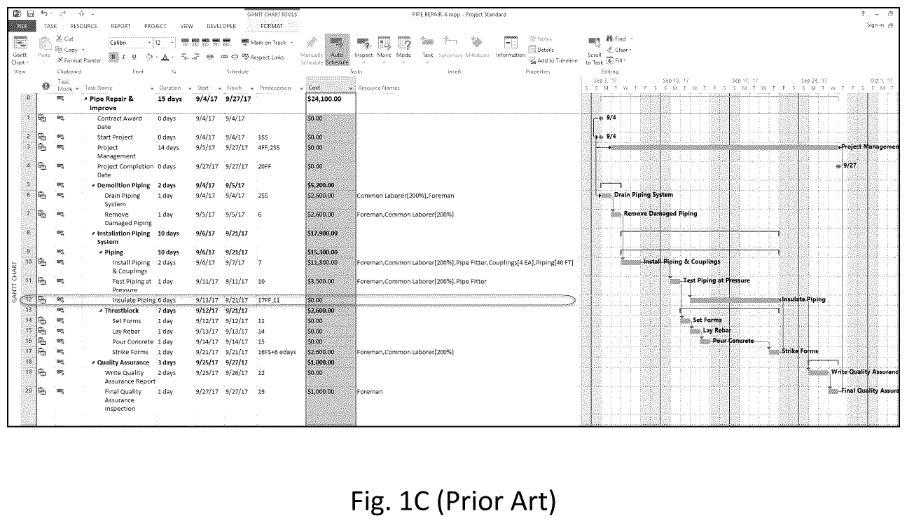

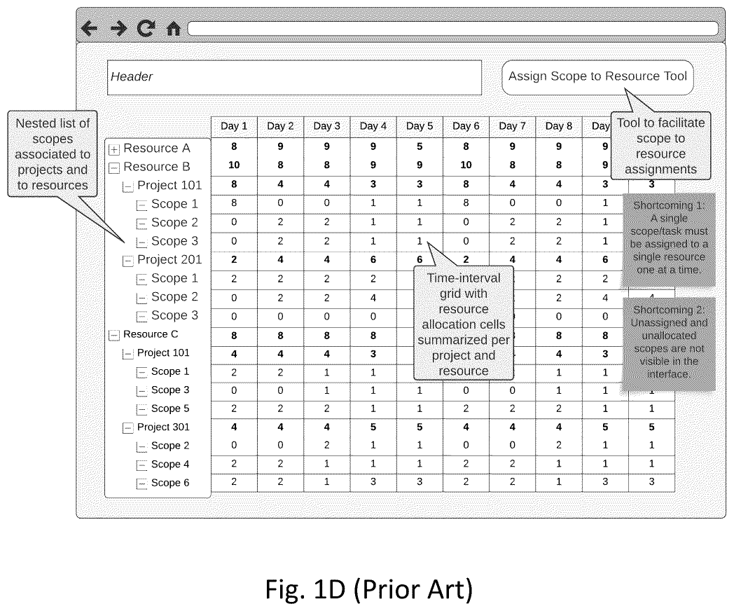

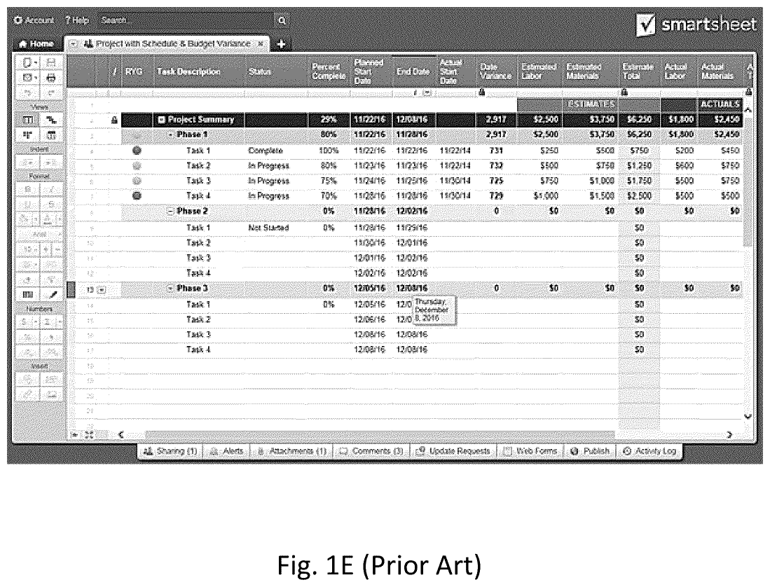

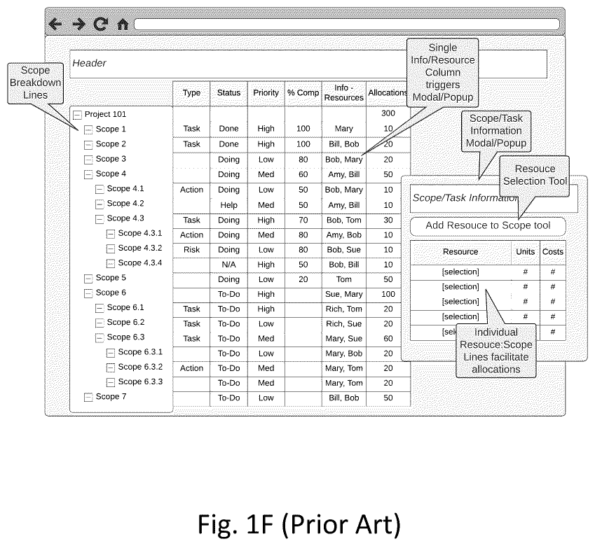

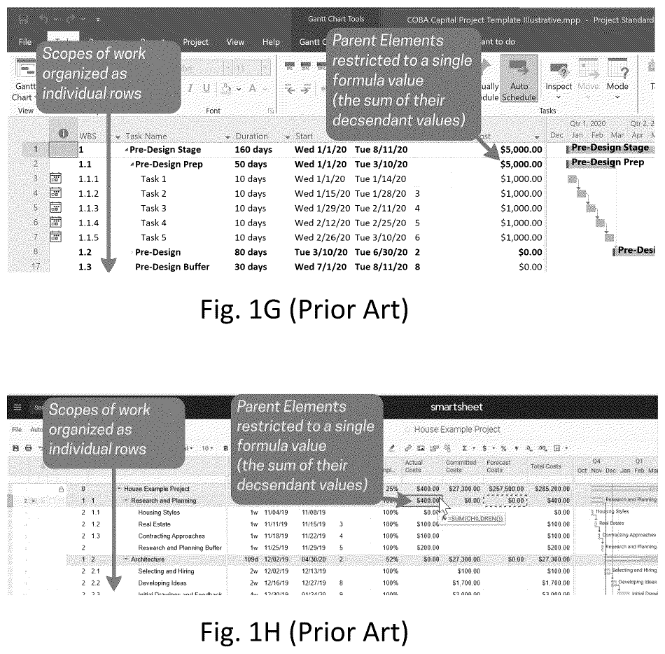

The allocation steps of the prior art system are listed below, and the navigation to the popup window is illustrated in FIGS. 1A and 1F.
1. Select a scope element on the WBS table and navigate away from the WBS table to a popup window for resources.
2. Select the resource.
3. Select a resource line cell in the popup window.
4. Allocate the resource level (cost, level of effort, etc.)
5. Repeat steps 3 & 4 for each resource to be allocated to the selected scope element.
6. Close the popup window for the selected scope element when all resources have been allocated for the selected scope element and renavigate back to the WBS table.
7. Repeat steps 1-6 for the next scope element on the WBS table.

The reduction in the number of steps is provided by the equations below for assigning three (3) resources to work on fifty (50) different scope. The 303 user actions with the present invention's system results in a 45% decrease of necessary user actions from the 550 user actions with a representative prior art system. This results in a significant decrease in the user's effort and time that it takes to enter the data. When the inefficiencies in the fifty (50) user actions associated with the navigation away from the WBS table and then the fifty (50) user actions in renavigating back to the WBS table are taken into account (considering the time savings between the nature of the user interactions, i.e., repeated clicking delays on changing screens compared to rapid movements in the single workspace of the scope-resource matrix), the present disclosure results in greater than 90% reduction in the time and effort as compared to prior art systems.

$$Equation 1 - Present System$$

$${\sum }_{n = 3} ( Resource ) + {\sum }_{n = 50} ( {\sum }_{n = 3} ( Scope : Resource + Allocation ) ) = 303 user actions$$

$$Equation 2 - Representative Prior Art System$$

$${\sum }_{n = 50} ( Scope + {\sum }_{n = 3} ( Resource + Line + Allocation ) + Renavigate ) = 550 user actions$$

As evident from the steps listed above, the user can view, allocate, edit, and manage all resources for all scope elements on the WBS table, without having to navigate away from the WBS table, which saves significant amounts of time for the user. In the prior art systems, users are only able to view resources, amounts and costs for one scope element at a time when viewing the WBS table so there is no way to view the resource data for all scope elements at the same time unless the user navigates to a different workspace, such as in a workload view or in a resource management system. Also, since all of the allocations are in the WBS table's scope-resource matrix in the present invention, the user can view the total allocation of a single resource (resource column) across multiple scope elements (task/subtask rows) and can look across a scope element (task/subtask row) to identify the resources allocated to the scope element. In the prior art systems, a user would have to navigate to a different workspace to view the total allocation of a single resource across all scope elements. In the present invention, users select and add resources to the WBS table only once which makes the resource available for allocation to all of the scope elements. In comparison, prior art systems are very cumbersome and time consuming because users must select and add resources to each individual scope element which forces the user to repeat this process for each scope element.

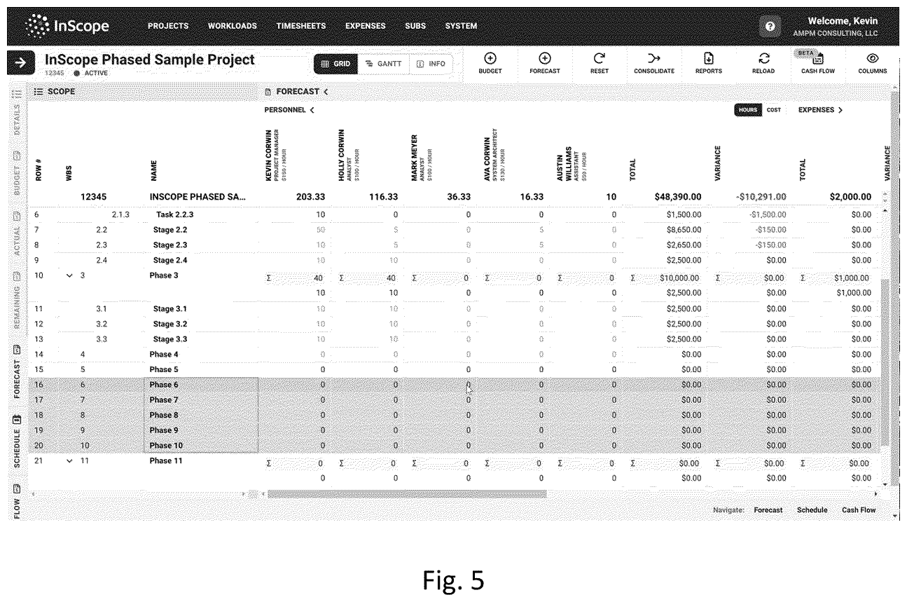

Showing the scope to resource associations and the scope to schedule associations on the same enhanced WBS table workspace of the present disclosure provides for some unanticipated advantages over the traditional methods of displaying the allocations of resources in individual popup screens for the various tasks or in entirely separate workspace views, such as in a resource management system or a workload view. For example, by displaying the allocations of the resources in the scope-resource matrix with the tasks in the enhanced WBS table, available resources are more readily apparent, and the tasks without any resources assigned can be more easily identified. For example, as shown in FIG. 5, an entire group of tasks without any assigned resources a clearly identified by the null set in the scope-resource matrix as well as the zero dollar amounts in the financial summary column for the personnel resource group. In the prior art systems, the traditional WBS table fails to provide a visual indication of available resources for various scope elements as well as the unassigned and unallocated scope elements. In those systems that allow users to list the resources for a scope element in a single column, the level of effort for the various resources cannot be ascertained by viewing the WBS table. In current systems that allow the user to apply a single % allocation for the resources assigned to each task

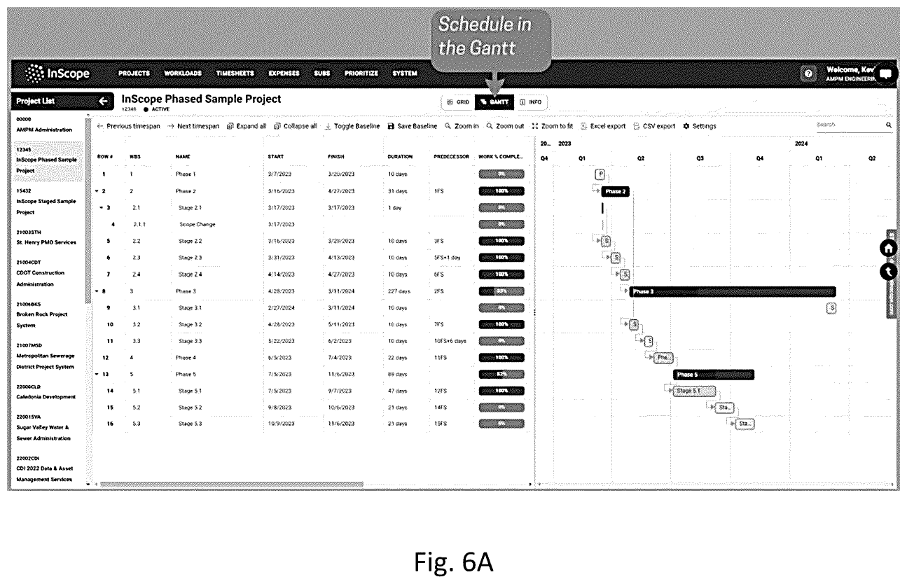

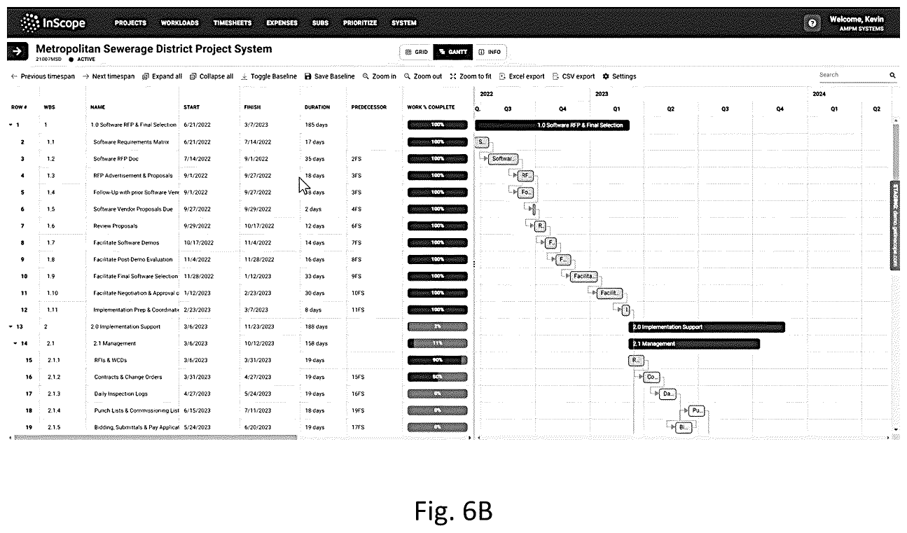

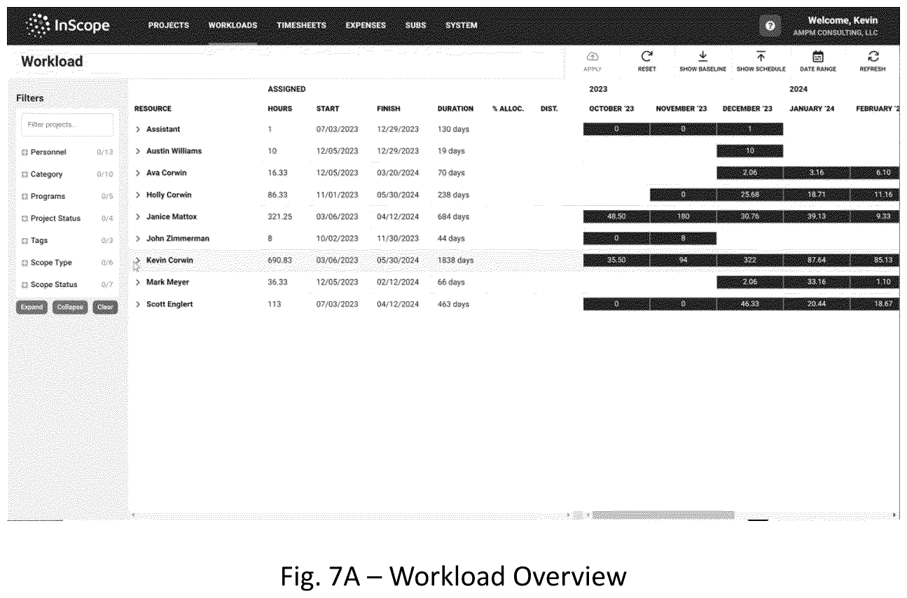

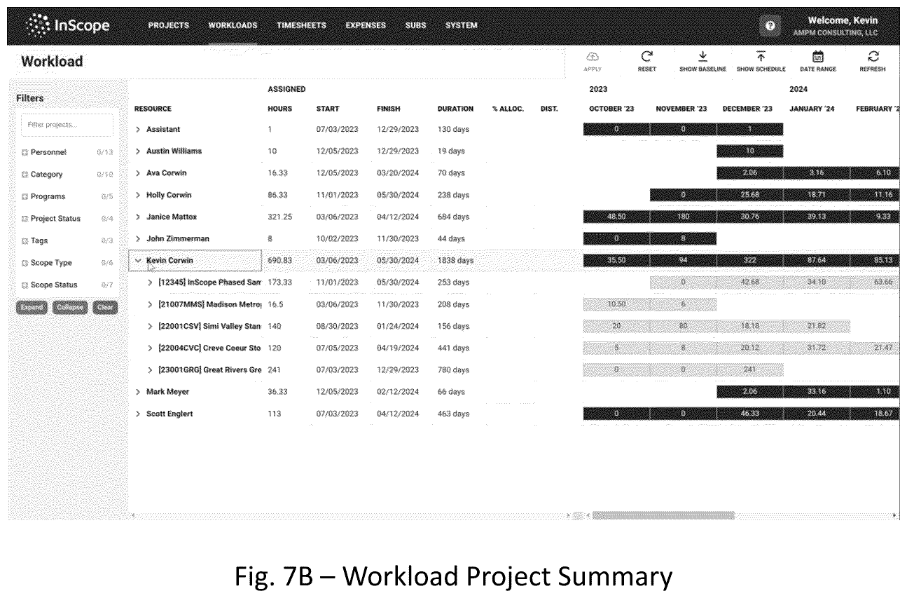

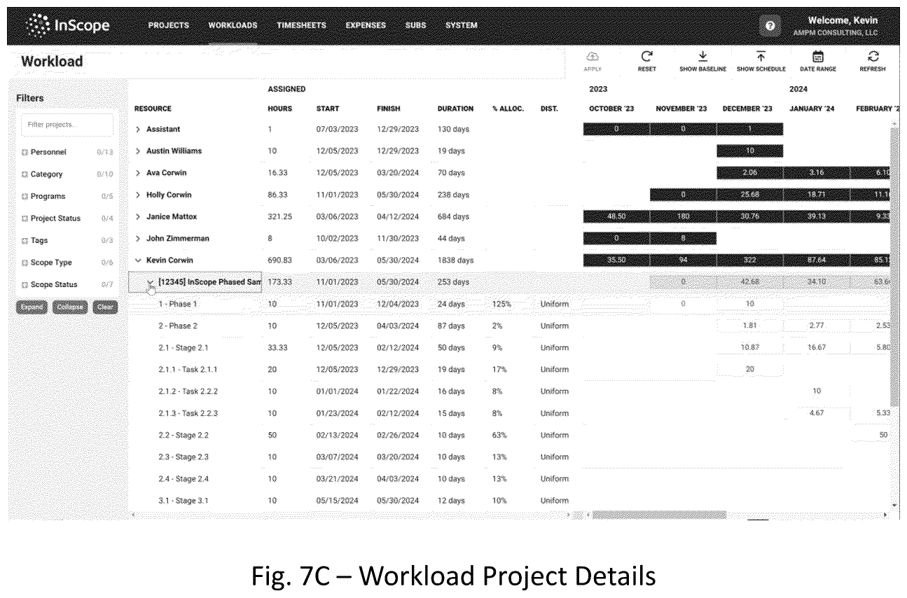

The present invention's computer-implemented project management system of the displays the Gantt chart in the same general manner as the prior art systems except that the WBS table also displays the resource-scope matrix in addition to the standard information displayed for the project's tasks and the corresponding details and schedule for the tasks. Examples of the Gantt chart display in the present disclosure are shown in FIGS. 6A and 6B. The Gantt chart is a graphical representation of the scheduled timespans and dependencies of respective scope tasks/subtasks common in the art of project management. But the present disclosure enables a user to perform schedule management within the WBS table (again without switching workspaces). Additionally, the present invention's system can convert the scope-resource matrix for the allocated tasks into a workload table, such as shown in FIGS. 7A-7C. The workload table is similar to the workload workspace found in other project management systems in which start dates and end dates respectively populate the start date fields and the end date fields for the various allocated tasks, such as shown in FIG. 1D. In the workload table, each resource that is assigned and allocated to any task in the project is listed in a workload row so there is a single allocated resources column. Each one of the tasks to which the resource is assigned can be displayed in rows beneath the particular resource. Timelines according to the start dates and end dates of the various scope elements can display the allocation level within selected units of time along the timeline. The unallocated tasks are not included in the workload table, and in the present invention's system, the user is able to quickly scan the scope-resource matrix to identify the unallocated tasks that have not yet been assigned any resources.

According to the present invention, the incorporation of the scope-resource matrix into the WBS table results in an efficient, intuitive, and time-saving interactive display workspace for a computer-implemented project management system which provides users with the ability to view and manage total amounts or costs per resource and individual amounts or costs per scope element for each resource without having to open other programs or navigate to different windows. When the system first creates a new project, it creates scope element rows for each one of the task items that the user enters into the task fields, and it creates resource columns for each one of the resource names that the user enters into the resource identifier fields. As explained above, these scope element rows and resource columns form the scope-resource matrix in the WBS table, and the resource allocation fields are each one of the intersections of the rows and columns in the matrix. The resource allocation fields begin with a null value which can be zero or nothing in the field. When the user enters a non-zero value in a resource allocation field, the nonnull value indicates to the system that the resource is assigned to the task item for the allocation provided by the nonnull value. As explained in detail below with regard to the grouping and management of the columns, the user has significant flexibility on how to display the columns of resource allocation data in the scope-resource matrix as well as the other columns of data in the WBS table, such as the project scope columns, the project details columns, and the financials columns.

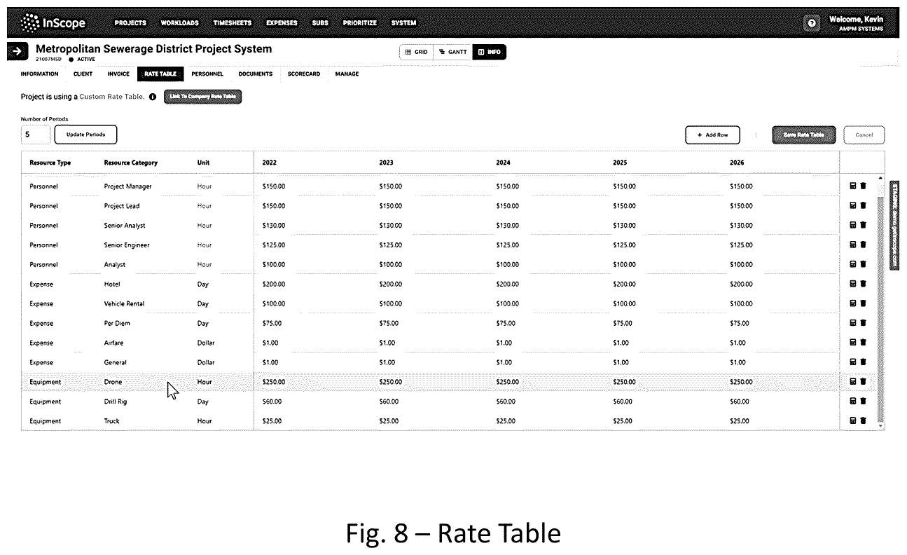

As shown in FIG. 8, the present disclosure includes one or more rate tables in which each one of the resources can be assigned to a category that is measured in particular units. In the rate table, a resource rate can be applied to at least some of the resources, such as setting hourly rates for personnel or daily rates for rental vehicles or equipment. Depending on the particular type of project and the industry in which the project is being performed, resources could take a lot of different forms. Many projects will include personnel, tools, equipment and materials, and expenses, such as travel and lodging and could also include subcontracted work. It is also possible to provide custom rates for particular projects. As the user allocates resources to the various tasks in the scope-resource matrix, the system can automatically calculate the project's financial budget information. In particular, the value entered into the resource allocation field multiplied times the resource rate for each one of the resources allocated to the task can be summed to provide the budget amount for the particular task item. These calculations can be performed for the resources allocated to each one of the task items to provide an overall budget for all of the tasks in the project.

In some prior art project management software systems, such as shown in FIG. 1B, it is possible to add columns into the WBS table. However, the columns created by the prior art systems do not have the functionality of the resource columns in the present invention. Even if the user enters resource names in the headings of these columns, there would not be any linkage to a rate table for the resources because the functionality is not incorporated into these columns of information. The user could enter rates for the resources in corresponding rate fields and manually enter multiplication and summation operations in a budget column to give the appearance of the functionality of the resource columns in the present invention. However, even with all of these manual tasks for mock resource columns, the prior art systems do not have the functionality of the present disclosure which directly links the allocated resources to the corresponding tasks. Without this functionality, there is no way for these prior art systems to convert the data entered into these mock resource columns into a workload table. Accordingly, the linkage between allocated resources and the corresponding scope elements is new, innovative functionality incorporated into the scope-resource matrix that is not found in prior art systems.

As with many other project management software tools, the present disclosure has a timesheet module which allows users to enter into the system the hours that they have worked on various projects. In prior art systems and in the present invention, this timesheet information is automatically updated in the data tables for the corresponding resources. However, in the prior art systems, the data is not shown directly on the WBS table whereas the present disclosure displays the updated data on the scope-resource matrix in the WBS table. The timesheet functionality can also be in a separate timesheet program, and the data is automatically communicated to the project management system through an application program interface (API) between the programs.

The present disclosure allows users to allocate amounts or costs of multiple resources for multiple scope elements within the single workspace of the scope-resource matrix in the WBS table without having to navigate away from the WBS table workspace. Since multiple resource allocations can be performed against multiple scope elements with single mouse clicks and/or keystrokes, the system provides the user with a more efficient tool that reduces the time that it takes to enter the resource allocation data and reduces the fatigue on the user since they do not need to navigate to different screens to enter the data. Additionally, the tables of the present disclosure are formatted to automatically calculate financial information based on the rate tables and the allocation values entered into the resource allocation fields in the scope-resource matrix. The resources for a project, their allocated amounts and/or costs, and the relationships of these resources with the scope elements are visible and manageable within the single workspace of the scope-resource matrix in the WBS table which provides the user more clarity, access and insight to the overall project.

### Composite Operator-Data Field Innovation

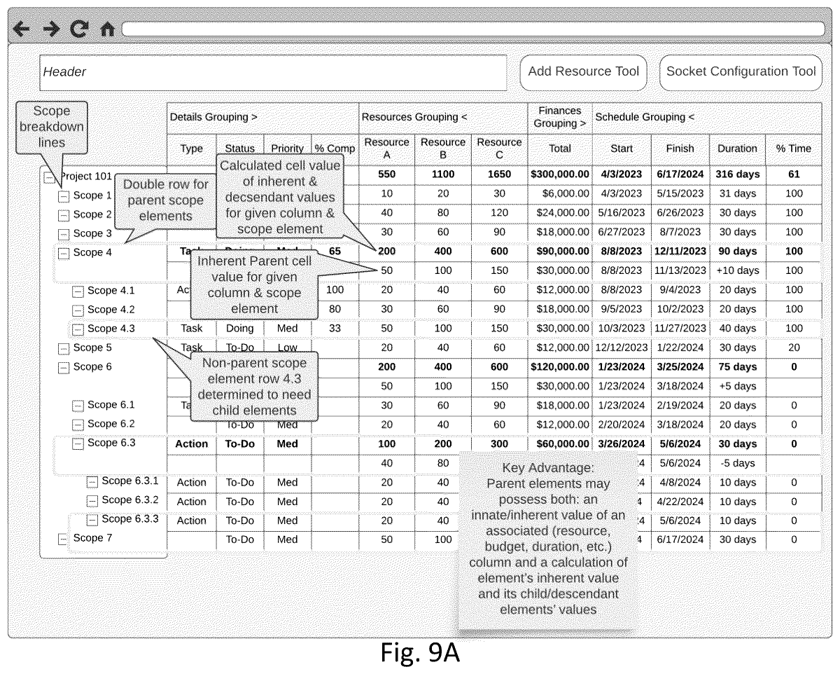

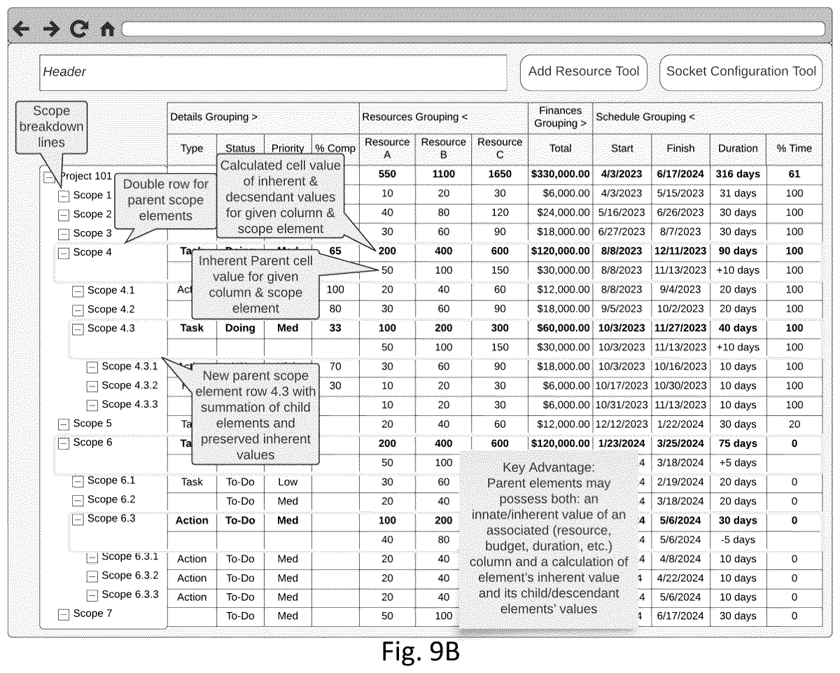

The present invention's project management system has created a new composite operator-data field where parent tasks are able to possess and display their own data value, i.e., an inherent parent value, in addition to the operator that is found in other project management systems. Examples of the composite operator-data field are shown in FIGS. 9A and 9B. The composite operator-data field allows users to assign an inherent value to the parent task elements which is independent of the operator calculated value that is based on the values in the subtask elements. The parent task elements possess their own inherent allocation value which may be included in a secondary formula value that is combined with values allocated to the subtask elements. When the present disclosure creates a parent task row, those fields that had been data fields are changed into two rows-one for the calculated formula and one for the parent task element's inherent value. In this way, associated (resource, budget, duration, etc.) column values may be allocated at any level of scope element within a breakdown structure.

As one example use of the inherent parent value, consider a program manager whosc time for coordinating the work across a task element can be estimated generally but does not really belong in any one particular subtask. With the present invention, the program manager's coordination time can remain as an inherent value while the time for the more task-specific staff members is divided into the subtask elements.

As another example of the inherent parent value, the date field could have its own overall time which could provide some flexibility to the schedule. In current systems, the duration of a parent task is determined based on the overall duration of its children subtasks with a start date logical operator that selects the earliest of the start dates in the set of subtasks and an end date logical operator that selects the latest of the start dates in the set of subtasks. The user cannot edit the calculated duration. Instead, the user can only control the times for the schedule in the child subtasks. With the use of the inherent parent value for the schedule, the inherent duration of a parent task element now has additional flexibility. For example, a project manager may want the parent task to be scheduled five (5) days less than the sum of the child subtasks so a negative five (−5) value could be used in the inherent parent schedule field. It may also be possible to have an cither-or situation which may be customizable, such as with a maximum time operator. With a maximum mathematical operator, the user could set sixty (60) days for the inherent value. If the 60-day duration is greater than the sum of the children subtask duration, the parent task would use the 60-day duration instead of the lower sum, and if the sum of the children subtask duration is greater than the 60-day duration, the higher some would be used.

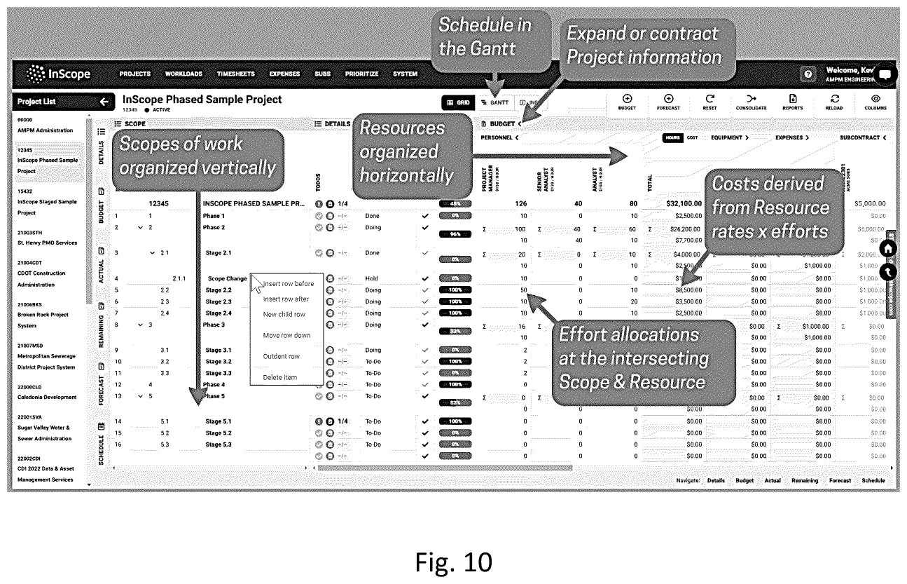

The method for creating the parent task rows with composite operator-data fields is described in the steps below for the project management system according to the present disclosure which operates on a computer processor in operative communication with a data memory, an input interface, and a monitor screen. The input interface can be a keypad, a mouse, and/or a touchscreen display. The method includes:
1) Automatically create in the computer processor a set of default instructions for displaying on the monitor screen a WBS table which has a set of tasks arranged in the rows of a column. As described above, the WBS table has start dates and end dates in another couple of columns and at least one additional column formatted as a numerical data field.
2) Store in the data memory a set of task names received from the input interface and corresponding with the set of tasks.
3) Receive in the computer processor a subtask instruction from the input interface for a selected task in the set of tasks. As shown in FIG. 10, in addition to giving the user the option for creating a new task row which can be before or after the current row, the system gives the user the option for creating a subtask child row.
4) Create in the computer processor a set of subtasks associated with the selected task according to the subtask instruction. Each subtask in the set of subtasks has an additional row that is arranged with the same columns as in the parent task, i.e., the column for the subtask name, the columns for the subtask start date and the subtask end date, and the column for the subtask numerical data.
5) Automatically reformat in the computer processor the column for the selected task from the numerical data field to a composite operator-data field, wherein the composite operator-data field is comprised of the numerical data field for the selected task and a data summation field for summing the subtask numerical data fields in the set of subtasks. Generally, the data summation field can be a data operator field that operates on the subtask numerical data fields.

The numerical data field can be a cost column, such as used in prior art project management software tools and shown in Figures IC, 1E, 1G, and 1H, or it can be one of many resource columns as described above or a summation financial column that is used with resource columns which is also described above.

### Grouped Columns Management Innovation

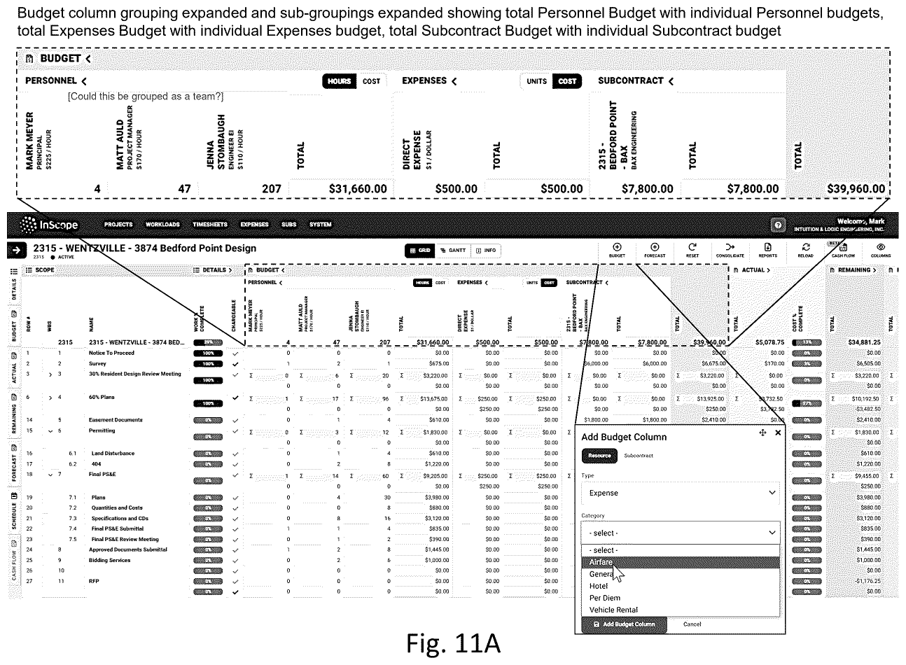

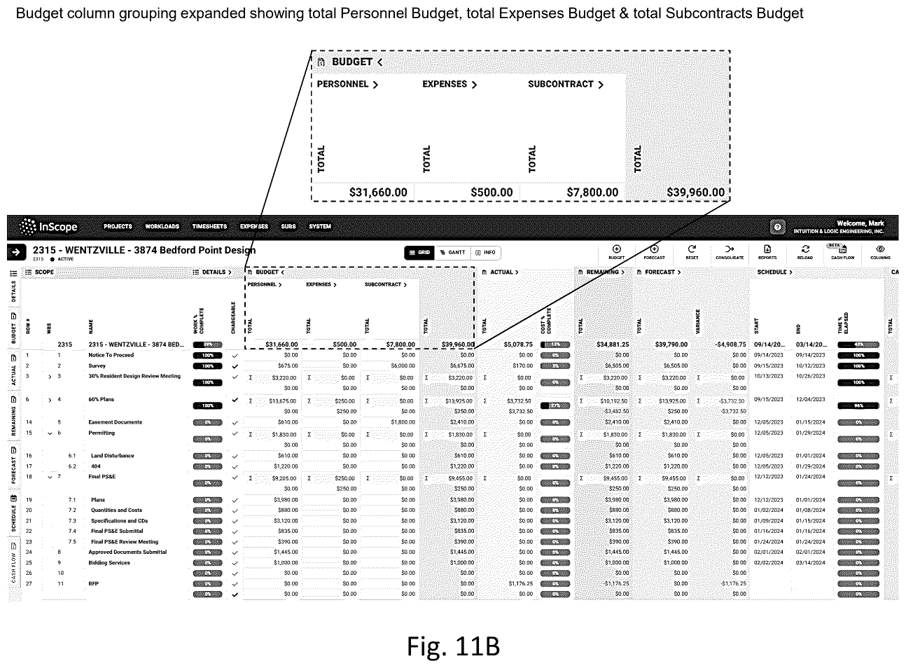

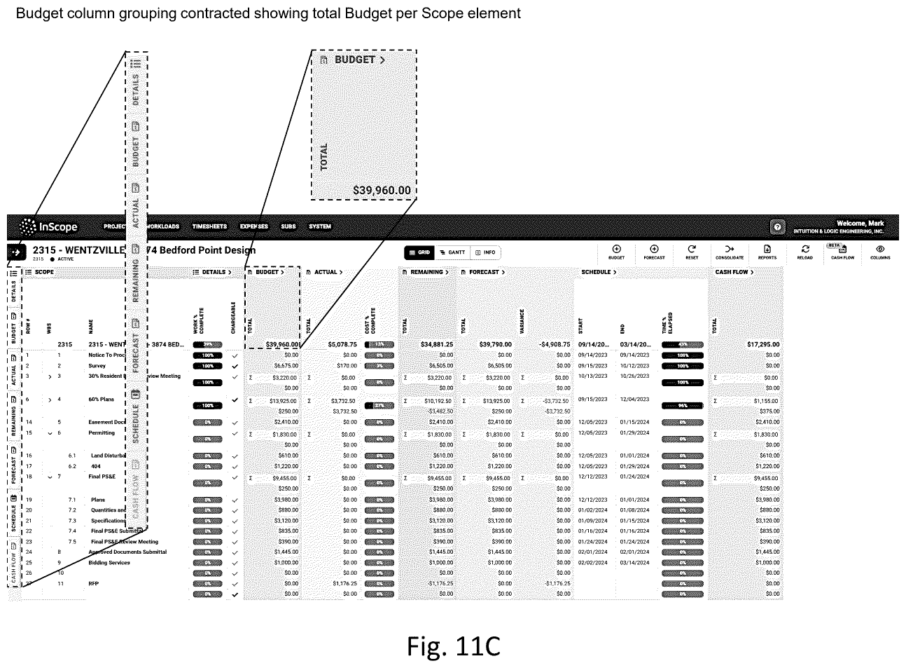

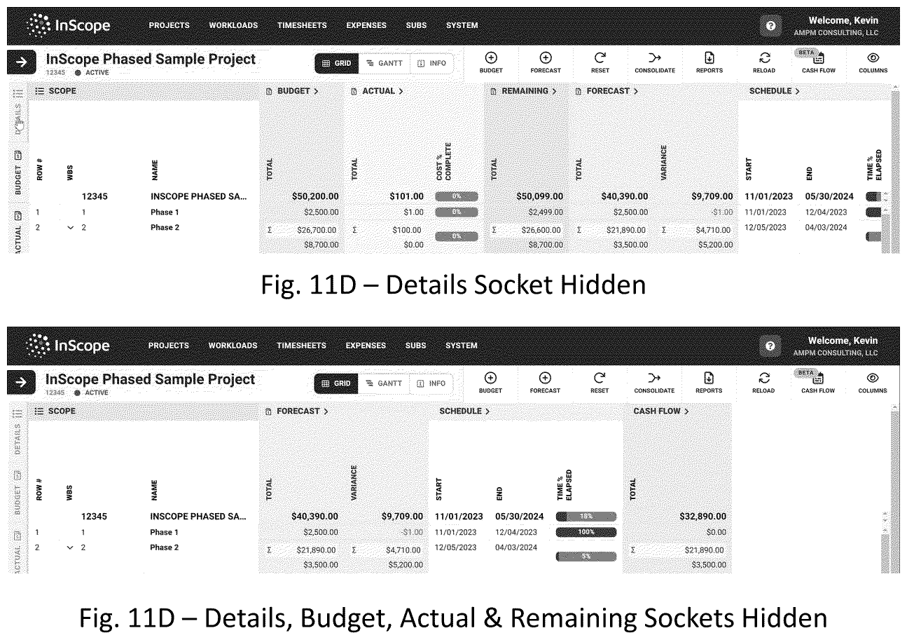

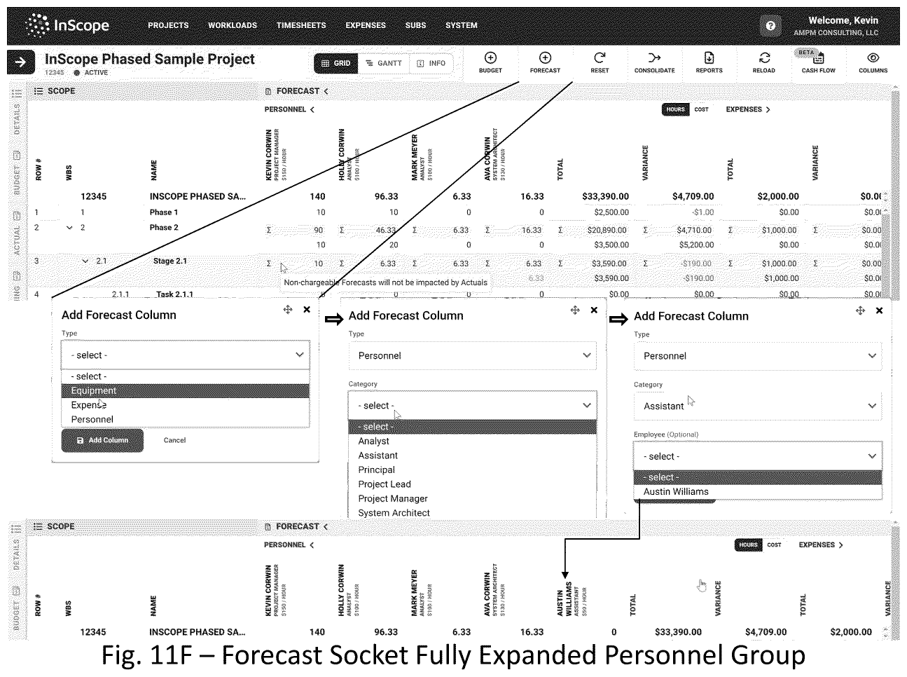

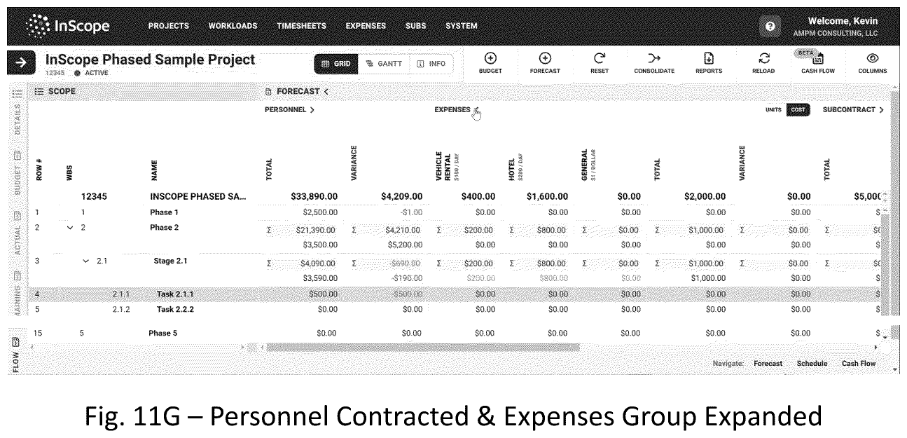

As explained above, prior art project management systems limit the information that is presented to the user in the WBS workspace view because they do not provide a scope-resource matrix in the WBS table. With the additional resource columns that can be displayed in the WBS table, the present invention's project management system allows the user multiple display options for these columns. Columns can be grouped in a hierarchical manner with groups and subgroups, such as shown with the Budget group in FIG. 11A which has subgroups for personnel, expenses, and subcontracts. The top level groups are generally referred to as sockets and are predefined by the project management system, including Scope, Details, Budget, Actual, Remaining, Forecast, Schedule, and Cash Flow. The data in groups of tables can be summarized with one or more aggregation columns for the respective groups and subgroups, such as shown by the personnel, expenses, and subcontracts subgroups for the Budget socket in FIG. 11B. The column groupings can be displayed in their entirety, without hiding any columns, or only the summary formats as shown in FIG. 11A.

As shown in FIGS. 11A-11E, the identification of these top level column groupings are preferably listed in a single row of socket selectors along one side of the WBS workspace view. As particularly shown by the screenshots in FIGS. 11D and 11E, the user can use the socket selectors to toggle between hiding and showing the sockets. For example, as shown in FIG. 11D, the socket selector for the Details socket is toggled to the hidden configuration, and the entire socket is hidden from view. The socket selector for the Budget socket, the Actual socket, and the Remaining sockets can also be toggled to the hidden configuration, and these sockets are also hidden from view in the screenshot shown in FIG. 11E.

As explained above, the column groupings allow the user to contract the columns to subgroups, single-column summaries, or even to hide entire sockets in order to facilitate a manageable use of screen space. As shown in FIG. 11F, it is also possible to expand out the socket to show all columns which can span extra-wide screens, multiple screens, and/or virtual screens displayed in headset monitors which are becoming more commonplace in modern office-spaces. The screenshots shown in FIG. 11F particularly illustrate how a user can use the present invention's system to add even more resource columns, further expanding the socket. The user can control the individual expansion and contraction of subgroupings, such as shown in FIG. 11G in which the Forecast's personnel group is contracted to only show the summary columns (total and variance) while the expenses group is expanded to show multiple expense columns (vehicle rental, hotel, general) as well as the total and variance columns.

The grid columns contained by the component are grouped under shared identifiers (for example: established “Budget” amounts, “Actual” amounts spent, future “Forecast” amounts, and more) and columns can also be further sub-grouped at additional levels (for example: all “Personnel” and “Expense” resources which are part of the “Budget”). These groupings allow users to contract the grouped columns to fewer or even one column to close what they do not need or expand columns to view, add and change data without leaving the workspace. This also facilitates a manageable use of screen space including the spanning of extra-wide and/or multiple screens.

The socket groupings and subgroupings are listed below.
Scope (row number, WBS hierarchy indicator, task descriptions)
Details (Type, Status, Priority, Tools, % Complete, To-Do Items, Program, Activity Code, Tags, Agile Score, Chargeable, Notes, Description)
Resources (Type, Name, Allocation Level, Rate)
Financials (Budget, Actual, Remaining, Forecast, Cash Flow)
Schedule/Time (Start Date, End Date, Task Relationships, % Time Elapsed)

It will be appreciated that alternative configurations can be defined, and the system can also allow for user-defined groupings. For example, with respect to resources, user-defined groupings can be created for different teams on a project, such as a design team, a pre-build team, and a build team.

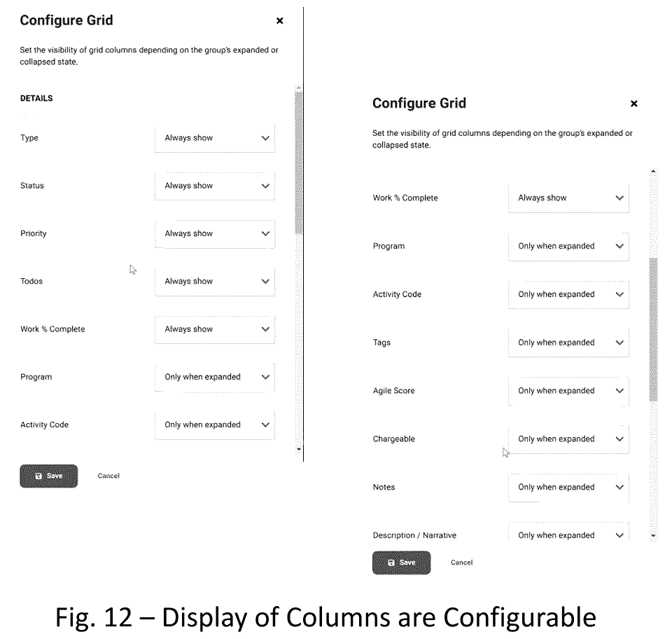

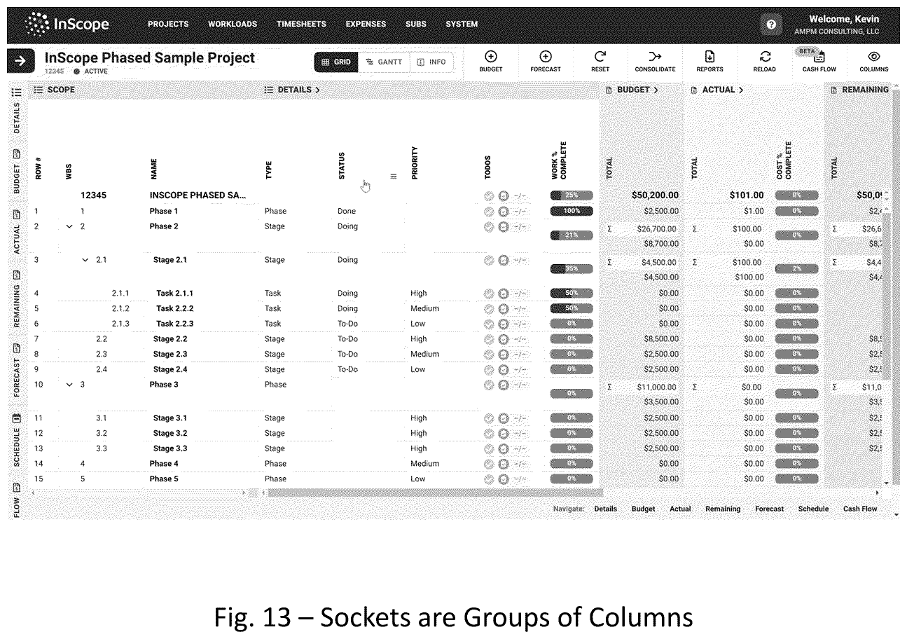

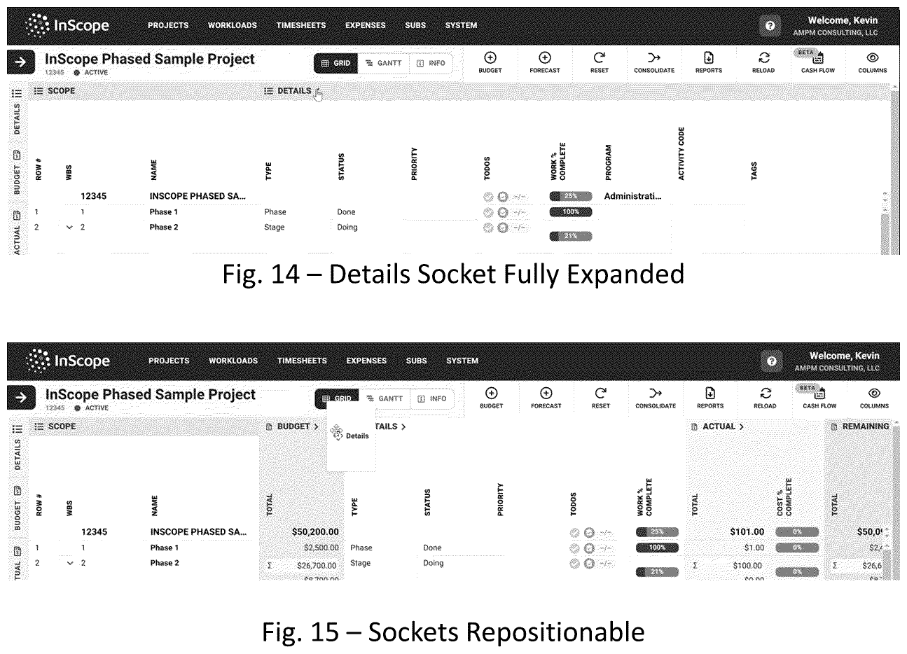

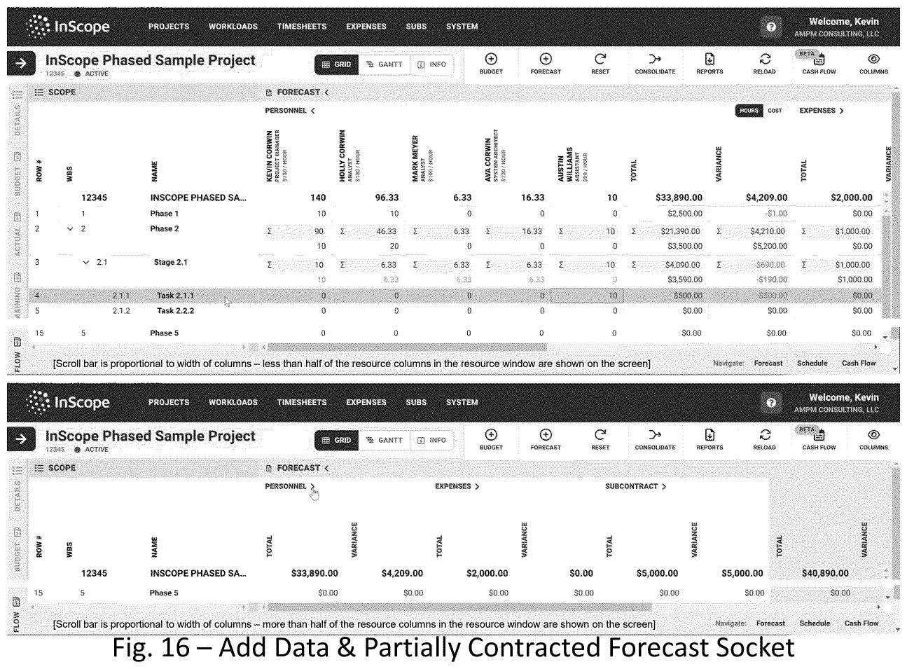

As shown by the socket configuration screen in FIG. 12, the mode of display for the columns can be configured by the user. Columns can be set to always be shown with the socket or can be set to be shown only when the socket is in its expanded mode of display. FIG. 13 shows the display of the Details socket based on the user-defined selection from FIG. 12, and FIG. 14 shows the Details socket when it is fully expanded to display all of the columns. The sockets are also repositionable on the WBS workspace as shown by FIG. 15.

As shown in FIG. 16, the resource fields that are entered into the Budget socket are automatically duplicated in the Forecast socket, and the data in the Budget socket's scope-resource matrix is automatically duplicated into the Forecast socket's scope-resource matrix. The data can be modified in the resource allocation data fields in the Forecast socket's scope-resource matrix, and this will appear as a variance from the data in the Budget socket. Additionally, a horizontal scroll bar is displayed at the bottom edge of the WBS workspace. Preferably, each socket has its own scroll bar which is proportional to the total width of the columns in the socket. For example, the top screenshot shows the Forecast socket fully expanded, and the scroll bar indicates that less than half of the columns in the socket are shown on the screen, and the bottom screenshot shows the Forecast socket with the personnel column grouping contracted, and the scroll bar indicates that more than half of the columns in the socket are shown on the screen.

Ancillary details associated with the scope are shown in the Details socket and include the type of task, the status of the task, the priority of the task, the percent complete, to-do items, program, activity code, tags, agile score, chargeable, notes, description, etc. The project heading is positioned proximate to the top edge of the WBS table/top row of tasks and can be located between the column name for the first column and the task rows in the first column.

The embodiments were chosen and described to best explain the principles of the disclosure and its practical application to persons who are skilled in the art. As various modifications could be made to the exemplary embodiments, as described above with reference to the corresponding illustrations, without departing from the scope of the invention, it is intended that all matter contained in the foregoing description and shown in the accompanying drawings shall be interpreted as illustrative rather than limiting. Thus, the breadth and scope of the present disclosure should not be limited by any of the above-described exemplary embodiments, but should be defined only in accordance with the following claims appended hereto and their equivalents.

What is claimed is:

1. An interactive display a computer-implemented project management system, comprising:
a work breakdown structure table comprising a plurality of columns and a plurality of rows;
a set of scope fields arranged in a first column of the columns in the work breakdown structure table, wherein the set of scope fields is comprised of a heading field and a plurality of task fields correlated to the heading field, wherein each one of the task fields corresponds with a corresponding one of the rows in the work breakdown structure table;
a first set of schedule fields arranged in a second column of the columns in the work breakdown structure table, wherein the first set of schedule fields is comprised of a plurality of start date fields correlated to the task fields in the corresponding rows of the work breakdown structure table;
a second set of schedule fields arranged in a third column of the columns in the work breakdown structure table, wherein the second set of schedule fields is comprised of a plurality of end date fields correlated to the task fields in the corresponding rows of the work breakdown structure table; and
a first set of resource fields arranged in a fourth column of the columns in the work breakdown structure table, wherein the first set of resource fields is comprised of a first resource identifier field and a first set of resource allocation fields correlated to the first resource identifier field and the task fields in a scope-resource matrix in the work breakdown structure table, wherein a null value in a first subset of the resource allocation fields corresponds to a first set of unallocated tasks in the task fields for the first resource identifier field, and wherein a nonnull value in a second subset of the resource allocation fields corresponds to a first set of allocated tasks in the task fields for the first resource identifier.

2. The interactive display of claim 1, wherein the first set of allocated tasks in the task fields for the first resource identifier are converted into a workload table, wherein a first set of start dates and end dates respectively populate the start date fields and the end date fields for the first set of allocated tasks, wherein the workload table for the first resource identifier is comprised of the first resource identifier in a first workload row and the first set of allocated tasks in a timeline according to the first set of start dates and end dates, and wherein the first set of unallocated tasks are not included in the first workload row for the first resource identifier.

3. The interactive display of claim 2, further comprising a second set of resource fields arranged in a fifth column of the columns in the work breakdown structure table, wherein the second set of resource fields is comprised of a second resource identifier field and a second set of resource allocation fields correlated to the second resource identifier field and the task fields in the scope-resource matrix in the work breakdown structure table, wherein the null value in a first subset of the resource allocation fields second set corresponds to a second set of unallocated tasks in the task fields for the second resource identifier field, and wherein the nonnull value in a second subset of the resource allocation fields second set corresponds to a second set of allocated tasks in the task fields for the second resource identifier.

4. The interactive display of claim 3, wherein the second set of allocated tasks in the task fields for the second resource identifier are converted into the workload table, wherein a second set of start dates and end dates respectively populate the start date fields and the end date fields for the second set of allocated tasks, wherein the workload table for the second resource identifier is comprised of the second resource identifier in a second workload row and the second set of allocated tasks in the timeline according to the second set of start dates and end dates, and wherein the second set of unallocated tasks are not included in the second workload row for the second resource identifier.

5. The interactive display of claim 3, further comprising a plurality of additional sets of resource fields arranged in corresponding additional columns in the work breakdown structure table, wherein each set of resource fields is comprised of a resource identifier field and a set of resource allocation fields correlated to the resource identifier field in the corresponding columns and the task fields in the scope-resource matrix in the work breakdown structure table, wherein the null value the resource allocation fields corresponds to sets of unallocated tasks in the task fields for each corresponding resource identifier field, and wherein the nonnull value in the resource allocation fields corresponds to sets of allocated tasks in the task fields for each corresponding resource identifier.

6. The interactive display of claim 5, further comprising a resource rate assigned to each of the resource identifiers and a first financial column comprised of a first set of summation rows corresponding with the task fields, wherein the nonnull value in the first set of allocated tasks and the second set of allocated tasks corresponds with a time value, wherein the resource rate multiplied times the time value for the first set of allocated tasks produces a first cost value for each one of the corresponding task fields for the first resource identifier, wherein the resource rate multiplied times the time value for the second set of allocated tasks produces a second cost value for each one of the corresponding task fields for the second resource identifier, and wherein the first cost value and the second cost value are summed in each one of the corresponding first set of summation rows in the first financial column.

7. The interactive display of claim 6, wherein the fourth column and the fifth column are shown with the first financial column in a first configuration of the work breakdown structure table, wherein the fourth column and the fifth column are hidden in a second configuration of the work breakdown structure table, and wherein with the first financial column is shown in the second configuration of the work breakdown structure table.

8. The interactive display of claim 6, further comprising a second financial column comprised of a second set of summation rows, wherein the nonnull value in the plurality of additional sets of resource fields is an expense value, wherein the expense value for the sets of allocated tasks in the task fields for each corresponding resource identifier is summed into the corresponding second set of summation rows in the second financial column.

9. The interactive display of claim 8, further comprising a third financial column comprised of a third set of summation rows, wherein the rows in the first financial column and the second financial column are summed into the rows of the third financial column.

10. The interactive display of claim 9, wherein the work breakdown structure table is further comprised of a vertical scroll bar, a first horizontal scroll bar, and a second horizontal scroll bar, wherein the vertical scroll bar is positioned adjacent to a column located at a side edge of the interactive display, wherein the first horizontal scroll bar and the second horizontal scroll bar are aligned with each other and are positioned adjacent to a row located at a bottom edge of the interactive display, wherein the first column for the set of scope fields scrolls in the first horizontal scroll bar, wherein the fourth column, the fifth column, the additional column, the first financial column, the second financial column, and the third financial column scroll in the second horizontal scroll bar, wherein a first configuration of the work breakdown structure table shows the fourth column, the fifth column, the first financial column, the additional columns, and the second financial column, and the third financial column, wherein a second configuration of the work breakdown structure table shows the first financial column, the second financial column, and the third financial column and hides the fourth column, the fifth column, and the additional columns, wherein a third configuration of the work breakdown structure table shows the third financial column and hides the fourth column, the fifth column, the additional columns, the first financial column, and the second financial column, and wherein the second horizontal scroll bar expands to a wider horizontal scroll distance in the first configuration and contracts to a narrower horizontal scroll distance in the second configuration.

11. A method for formatting an interactive display for a project management system, comprising the steps of:
providing a computer processor in operative communication with a data memory, an input interface, and a monitor screen;
automatically creating in the computer processor a set of default instructions for displaying on the monitor screen a work breakdown structure table comprising a first column, a second column, a third column, and a fourth column, wherein a plurality of rows in the first column are formatted for a set of tasks, wherein the second column and the third column are formatted for respective sets of start dates and end dates corresponding with the set of tasks in the plurality of rows, and wherein the fourth column is formatted as a numerical data field corresponding with the set of tasks in the plurality of rows;
storing in the data memory a set of task names received from the input interface and corresponding with the set of tasks;
receiving in the computer processor a subtask instruction from the input interface for a selected task in the set of tasks;
creating in the computer processor a set of subtasks associated with the selected task according to the subtask instruction, wherein each subtask in the set of subtasks is comprised of an additional row having the first column for the corresponding subtask and a subtask name, the second column for a subtask start date, the third column for a subtask end date, and the fourth column for the subtask numerical data; and
automatically reformatting in the computer processor the fourth column for the selected task from the numerical data field to a composite operator-data field, wherein the composite operator-data field is comprised of the numerical data field for the selected task and a data summation field for summing the subtask numerical data fields in the set of subtasks.

12. The interactive display of claim 11, further comprising the steps of:
automatically reformatting in the computer processor the second column for the selected task from the start date to a composite operator-start date field; and
automatically reformatting in the computer processor the third column for the selected task from the end date to a composite operator-start date field.

13. The interactive display of claim 11, further comprising the steps of:
automatically creating in the computer processor a set of column names for the respective columns in the work breakdown structure for displaying on the monitor screen, wherein the column names are positioned above the rows;
automatically creating in the computer processor a project heading field in the work breakdown structure for displaying on the monitor screen, wherein the project heading is positioned proximate to the top edge of the WBS table/top row of tasks; and
automatically creating in the computer processor a set of resource columns in the work breakdown structure table for displaying on the monitor screen, wherein each resource column in the set of resource columns is comprised of a resource identifier field and a first set of resource allocation fields corresponding with the set of tasks.

14. The interactive display of claim 13, further comprising the steps of:
automatically creating in the computer processor a plurality of groupings of resource column subsets from the resource columns in the work breakdown structure table, wherein each of the groupings is comprised of the resource columns and a financial summary column;
storing in the data memory a matrix of resource allocation values corresponding to the matrix of the rows for the set of tasks and the resource columns;
storing in the data memory a resource rate for each of the resource identifiers;
calculating in the computer processor for display in the financial summary column a summation of the resource allocation values multiplied times the resource rate in each of the rows for each of the resource columns; and
calculating in the computer processor a summation of the set of values in the subtasks and placing the summation in the identified task.

15. The interactive display of claim 13, further comprising the step of automatically creating in the computer processor groupings of columns as column sockets, wherein each of the column sockets can be shown in a first configuration of the work breakdown structure table and hidden in a second configuration of the work breakdown structure table.
